(19) United States
(12) Patent Application Publication
(10) Pub. No.: US 2007/0016365 A1
(43) Pub. Date: Jan. 18, 2007

(54) Vehicle position information providing device and method suitable to vehicle co-owner of multi-family house

(76) Inventors: Mi-Hyun Lee, Gimpo-si (KR); Eun-Kyung Go, Seoul-si (KR)

Correspondence Address: SHERMAN D PERNIA, ESQ., PC, 1110 NASA ROAD ONE, SUITE 450, HOUSTON, TX, 77058-3310, US

(21) Appl. No.: 11/202,623

(22) Filed: Aug. 13, 2005

(30) Foreign Application Priority Data
Jul. 13, 2005 (KR) 10-2005-0063139

(51) Int. Cl. G01C 21/00

(52) U.S. Cl. 701/207

(57) ABSTRACT

A vehicle position information providing device and method suitable to a vehicle co-owner of a multi-family house is provided. The device includes: a first card reader for reading vehicle relating information from a card provided to a vehicle; a second card reader for reading parking relating information from one of cards provided to vehicle co-owners; a parking and vehicle management server for previously storing information relating to the vehicle co-owners, and connected with the first and second card readers; a Web server for receiving advertisement message data from event companies and storing the received advertisement message data; and a short message transmitting server connected with the Web server, and transmitting the short message to wireless terminals of vehicle co-owners of the multi-family house.

### BACKGROUND OF THE INVENTION

1. Field of the Invention

The present invention relates to a vehicle position information service, and more particularly, to a vehicle position information providing device and method suitable to a vehicle co-owner of a multi-family house.

2. Description of the Related Art

In general, vehicle position information can be displayed on a map using a Global Positioning System (GPS). Accordingly, if a widely known navigation system is installed at the vehicle, a current driving position and a road selection up to a destination can be served in the vehicle.

However, in case where one family, or several ones of its constituents use one vehicle together in a multi-family house such as town house, villa, multi-family house or apartment, if any one co-owner parks the vehicle at a parking lot (under or outdoor parking lot) of the multi-family house, or drives the parked vehicle out, other co-owners are difficult to know entrance or unparking state of the vehicle or a parking position outside of the vehicle as it is. At this time, any one co-owner calls to other co-owners using a cellular phone to inform them of the current entrance/unparking state or parking position, thereby causing inconvenience and expenditure of calling fee. Even though parking his/her vehicle, there is a case that when a long time lapses or he cannot memorize clearly, it is difficult to search the parking position.

In a general multi-family house, a parking confirmation technology is embodied as just only an entrance/exit control system, and is just only controlled against the advance of a previously registered external vehicle, and in case where unspecified vehicle are parked in some shopping malls or grant parking lot, the parking position is indicated using a printed paper article outputted through a parking position recorder, and therefore it is insufficient to provide more convenient entrance/unparking or parking relating information.

Meantime, it is difficult that shopping malls subordinate to the multi-family house, peripheral shopping malls, or event companies such as remote advertisement provider concentratively transmit an advertisement message to constituents of the multi-family house. This is because there is not necessary information or appropriate transmittable information to a client being a constituent of the multi-family house. For example, in case where client desiring information is served or provided using the cellular phone, a cellular phone number of constituents of the multi-family house should know beforehand, but it is not only difficult to know the cellular phones number one by one, but also even though the cellular phone number is known, when only advertisement information unnecessary for the client is transmitted, the advertisement information becomes a spam message. Further, in case where separate outdoor advertisement or other advertisement method is mobilized and advertisement is executed for the constituents of the multi-family house, there is a drawback in that an advertisement cost is so expensive, thereby increasing a cost burden.

Accordingly, a preferable service technology is being required for clearly overcoming the conventional drawbacks to be helpful for the constituents of the multi-family house having the vehicle and allow the event companies to have a cost and publicity merit.

### SUMMARY OF THE INVENTION

Accordingly, the present invention is directed to a vehicle position information providing device and method suitable to a vehicle co-owner of a multi-family house that substantially overcome one or more of the limitations and disadvantages of the conventional art.

One object of the present invention is to provide a vehicle position information providing device and method, for providing vehicle co-owners of a multi-family house with vehicle position information, or existence or absence of vehicle theft, by a short message, without charge.

Another object of the present invention is to provide a vehicle position information providing device and method, for transmitting an advertisement company's desiring advertisement message to vehicle co-owners by a short message.

A further another object of the present invention is to provide a vehicle position and parking information providing device and an advertising method of an event company, which are helpful to multi-family house constituents owning a vehicle and provide a merit of saving an advertising cost to an event company.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a device for providing vehicle position information, the device including: a first card reader for reading vehicle relating information from a card provided to a vehicle at the time of entrance/unparking of the vehicle; a second card reader for reading parking relating information from one of cards provided to vehicle co-owners of a multi-family house at the time of parking of the vehicle; a parking and vehicle management server for previously storing information relating to the vehicle co-owners, and connected with the first and second card readers to receive the vehicle and parking relating information and perform a parking and entrance/unparking management of the vehicle; a Web server for receiving advertisement message data from event companies and storing the received advertisement message data, and connected to the parking and vehicle management server and the event companies through a communication network to generate vehicle position or state information relating short message data, which selectively includes the stored advertisement message data, at the time of the entrance, unparking or parking of the vehicle; and a short message transmitting server connected with the Web server, and when it is requested to transmit the short message data, transmitting the short message to wireless terminals of vehicle co-owners of the multi-family house.

In case where the vehicle co-owners receive the short message including the advertisement message, it may be set that a transmission cost of the short message is imposed on the event companies.

The vehicle co-owners can recognize vehicle theft or not by receiving the vehicle position and state information relating short message.

According to the present invention, there is an effect in that the vehicle co-owners of the multi-family house can receive the vehicle entrance, unparking or parking information or the existence or absence of the theft according to his/her desire, without charge by the short message, and the advertisement participating companies can transmit their desiring advertisement message to the vehicle owner and co-owners at a low price.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a whole system construction relating with provision of vehicle position information according to the present invention;

FIG. 2 is a flowchart schematically illustrating an example of transmitting advertisement information requested by event companies of FIG. 1;

FIG. 3 is a flowchart illustrating an example of operation control of a parking and vehicle management server of FIG. 1;

FIG. 4 is a flowchart illustrating an example of operation control of a Web server of FIG. 1;

FIG. 5 illustrates an example of a state where a vehicle position information and advertisement message is displayed on a screen of a vehicle co-owner's terminal, based on provision of a short message service according to the present invention;

FIG. 6 is a diagram illustrating an exemplary flowchart of a provision path of a short message service of FIG. 5;

FIG. 7 is a diagram illustrating interworking of detail data with a database of a database management system of FIG. 1;

FIG. 8 illustrates an example of a construction screen of a Homepage of a Web server of FIG. 1; and

FIG. 9 illustrates a whole flow of an advertisement agent request service in case where a SMS agent company is connected to event companies of FIG. 1.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

In the present invention, a vehicle position information providing device and method suitable to vehicle co-owners of a multi-family house is based on a service using a Short Message Service (SMS). In general, the SMS known in the art is a service for transmitting a short message to a cellular phone user connected to a cellular phone and a Personal Communication Service (PCS) being a mobile communication network in a Personal Computer (PC) connected using Internet network or dedicated line. A service provider being a sending side transmits service information to a client having a mobile communication terminal such as a cellular phone in a format of a short message. An amount of transmitted service information one time is about 80 bytes of forth characters in Korean and eighty characters in English.

The SMS can transmit a concurrent and large amount of information with rapid data transmission and broadcasting transmission and therefore, is economically cheaper than a direct mail (D/M) and a telemarketing (T/M) and is convenient in that it can receive and store information anytime and anywhere and can read information according to need.

If the multilateral vehicle position information SMS of the multi-family house is used in an apartment of a multi-family house by using the advantageous SMS, the vehicle co-owner being a tenant can receive a vehicle entrance/unparking and parking information service by a character message without charge when desiring to do, while receiving publicity and advertisement information combined thereto together. Further, the advertisement participating companies, that is, advertisers pay a low cost while advertising to apartment tenants being good clients, thereby maximizing a sale.

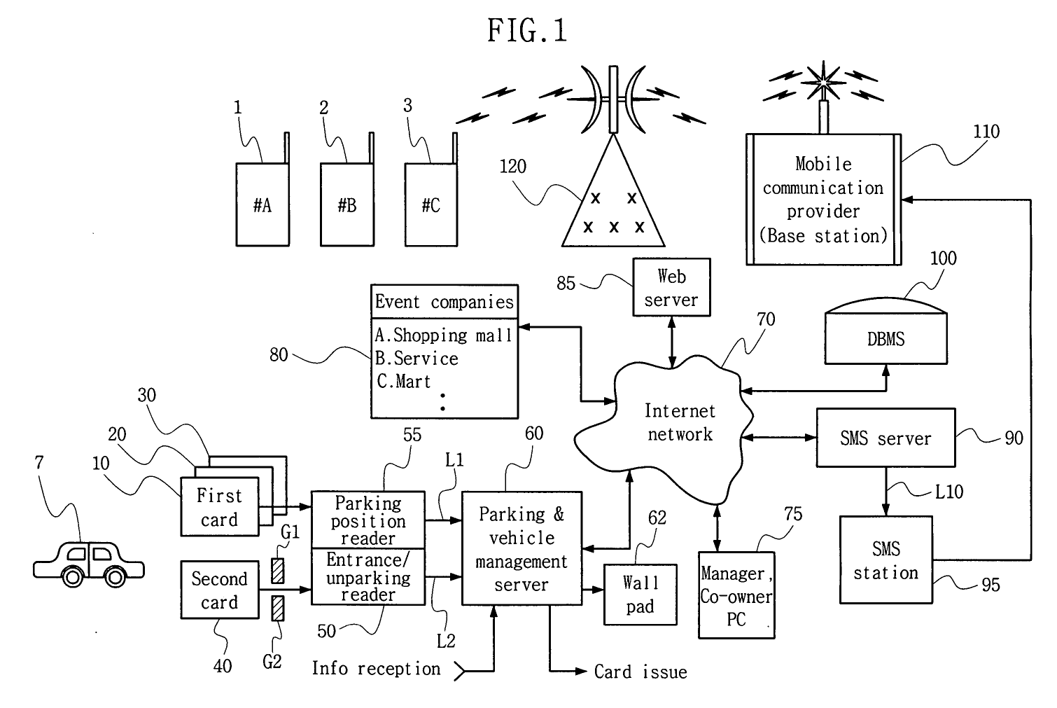

FIG. 1 illustrates a whole system construction relating with provision of vehicle position information according to the present invention.

Referring to FIG. 1, the inventive vehicle position providing device basically includes a vehicle entrance/unparking card reader 50 for, when a vehicle enters and unparks, reading vehicle relating information from a card provided for the vehicle; a parking position card reader 55 for, when one of cards provided for multi-family house vehicle co-owners from the card reader installed within a parking lot at the time of parking, reading parking relation information, for example, parking position information from the card; a parking and vehicle management server 60 having information relating to the vehicle co-owners previously stored therein, connected with the card readers 50 and 55 to receive the vehicle and parking relating information, and managing vehicle parking, and entrance and unparking; a Web server 85 for receiving and storing advertisement message data from event companies, connected to the parking and vehicle management server 60 and the event companies 80 through a communication network 70 to receive entrance/unparking and parking information from the parking and vehicle management server in entrance, unparking or parking of the vehicle, combining the received entrance/unparking and parking information with the advertisement message data of the event companies 80, thereby generating vehicle position or state information relating short message data selectively including advertisement message data; and a short message transmitting server 90 connected with the Web server 85, and transmitting the short message to wireless terminals 1, 2 and 3 of the multi-family house vehicle co-owners when it is required to transmit the short message data.

First cards 10, 20 and 30 are sensed using the parking position reader being the second card reader 55, and are contact cards respectively provided for the vehicle co-owners. A second card 40 is sensed using the entrance/unparking reader 50, and is a long-distance RF card provided for the vehicle. The contact card employs not only a direct contact card, but also a card indirectly read at a local distance. A construction can be employed such that when the vehicle equipped with the second card 40, an entrance gate (G1) is opened using a loop coil installed at an entrance of the parking lot, and when the vehicle is unparked, an exit gate (G2) is opened using a loop coil or unparking check data of the parking and vehicle management sever 60.

The parking position reader 55 is installed in plural at the parking lot, and reads the card and generates a parking area of a corresponding vehicle as parking position data.

When the SMS server 90 request to transmit the short message, a SMS station 95 transmits the requested short message to a mobile communication service provider.

A wall pad 62 is installed at a vehicle owner's home, and displays entrance/unparking and parking position on its screen when a home automation device interworks with the parking and vehicle management server 60.

Manager and co-owner PCs 75 are connected with Internet network 70, and can access to the parking and vehicle management server 60, the Web server 85, the event companies 80, and the SMS server 90.

The event companies 80 of advertisers represent servers of the event companies, and store data in their corresponding databases using database management system 100.

The SMS server 90 is connected with the SMS station through the Internet or a dedicated line (L10), and the SMS station 95 is connected with a base station 110 of the mobile communication service provider 110.

In the above description for FIG. 1, the Web server 85 generates the vehicle position or the state information relating short message data selecting including the advertisement message data, but in a different case, the parking and vehicle management server 60 receives the advertisement message data from the event companies 80 through the communication network 70, and combines the received advertisement message data with the vehicle parking position or entrance/unparking information, thereby generating the vehicle position or the state information relating short message data selectively including the advertisement message data.

If the base station 110 wireless or wire receives the short message, and wireless transmits the received short message, the wireless terminals 1, 2, and 3 of the multi-family house vehicle co-owners receives the short message directly through the base station 110, or through a relay station 120, and displays the received short message on its screen.

In case where the SMS server and the event companies are build-up on the basis of the Web server 85, using the Internet or the dedicated line, the vehicle co-owner of a household of an apartment being one of the multi-family house can receive the SMS service through a subscriber member database, management and reservation system. At this time, when the subscriber uses the Web server or a separate SMS service agent he/she can receive information on a demander needing a free-charge service for vehicle position information, news of a complex, advertisement of a shopping mall, and publicity without charge, instead of a conventional charged SMS service.

For a multilateral vehicle position information SMS between the vehicle co-owners in the multi-family house, the household vehicle co-owner should determine whether or not to use the SMS service with charge or without charge before registration. If using the SMS service with charge, the household vehicle co-owner inputs and stores his/her vehicle registration number, name, building and room numbers, cellular phone number, reception or not of the SMS between the co-owners in a parking and vehicle server installed within the complex, interworks IDentification (ID) of the parking card and the vehicle card with the data server to store, read and compare vehicle entrance (first) information and parking (second) information through the vehicle parking and vehicle management server 60, thereby transmitting the information to a home automation managing device installed within the complex so that parking position notification based on the first and second information can be transmitted to the wall pad or a parking position notification displayable interphone installed within the household. At this time, the first and second information can use different cards or the same card. For example, the first information card is a vehicle dedicated card used as a long distance RF card and installed only at the vehicle, and the second card information is a proximal card or contact card provided to each of the vehicle co-owners and installed at a parking area. Further, if using the same parking card as that of the vehicle, the first and second information can use one card provided to each person, and the proximal card or contact card can be used as the card provided to and possessed by each vehicle co-owner. In the multilateral SMS service for the multi-family house vehicle co-owners, if the Web server 85 receives information from the first and second card, and transmits the vehicle position information to a registered constituent of the vehicle co-owners through the short message server 90, the parking position information is displayed on the cellular phone of the registered vehicle co-owner. Or, the SMS can be also constructed through an external Internet SMS service provider. The SMS construction is served with or without charge depending on co-owner's permission for advertisement transmission. In the case of charged service, the user should be charged. Even in the parking of the vehicle, when any one of the vehicle co-owners drives the parked vehicle, if the long distance RF card or the proximal or contact card is read through the card reader installed at the entrance/exit of the complex or the exit of a basement parking lot, information on unparking of the vehicle is transmitted to the Web server through the parking position management server, thereby notifying the corresponding household of the vehicle position and transmitting the SMS data to the vehicle co-owners at the same time. Accordingly, the vehicle co-owner using the vehicle position information service can receive vehicle position information any time, and within the household and anywhere outside of the household, without temporal and spatial limitation. Accordingly, even when a different co-owner intends to drive the vehicle a few days later after the parking of the vehicle, he/she can know the information through the wall pad or personal cellular installed within the household, thereby making it possible to achieve convenient use. At this time, the information on the parking and unparking can be known using continuously updated data on final parking and unparking drivers by updating parking record and unparking record made with reference to the last data by the person's possessing proximal or contact card. For example, when any of the vehicle co-owners parks the vehicle, information on the parking driver as the first information of the proximal card or the contact card is read using previously inputted personal information. When the proximal card is used at the time of unparking, the first information is updated and secondarily inputted personal information is read, thereby storing information on the unparking driver in the parking and vehicle management server 60 and transmitting the information to the household wall pad and personal cellular phone. The unparking information can prevent and promptly cope with the vehicle theft accident as the vehicle unparking information is received even though the driver does not exist.

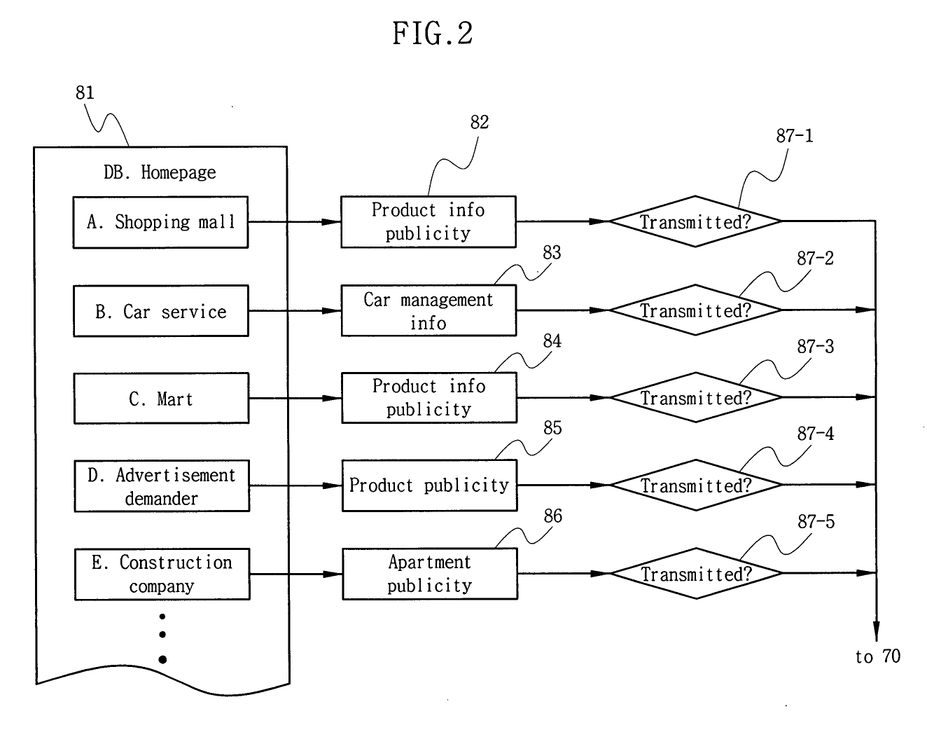

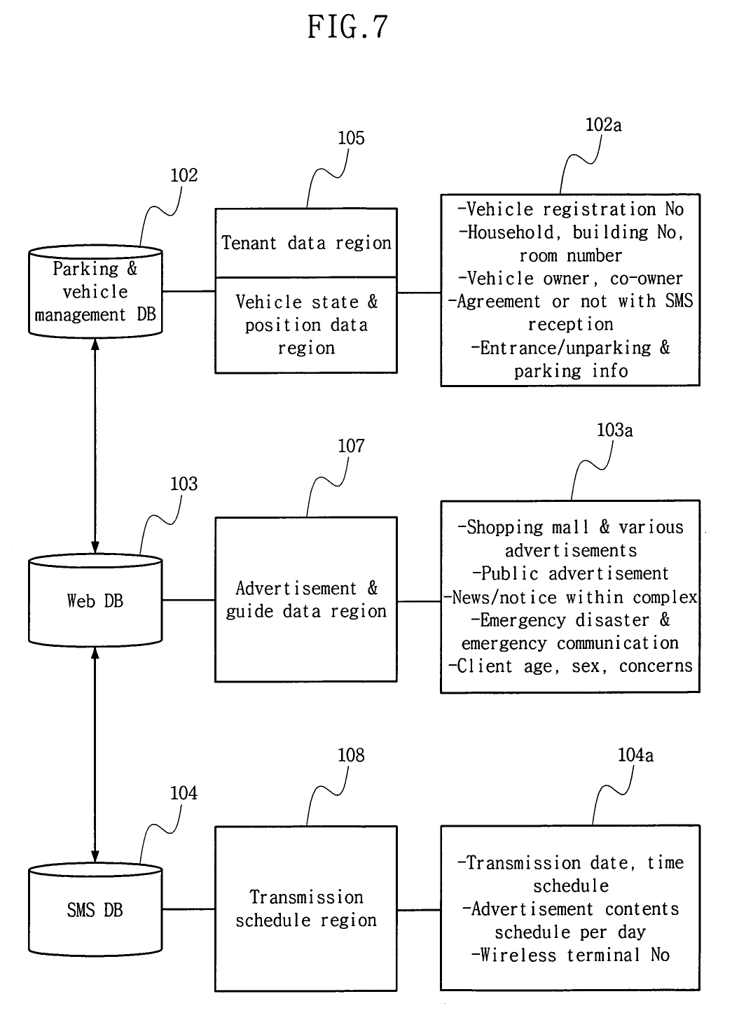

FIG. 2 is a flowchart schematically illustrating an example of transmitting advertisement information requested by the event companies of FIG. 1. FIG. 2 illustrates a partial construction 81 of a Home page stored in a database. For example, “A” denotes a shopping mall, “B” denotes a car service, “C” denotes a mart, “D” denotes an advertisement demander, and “E” denotes a construction company relating to apartment construction. The shopping mall is subjected to a product information publicity process in Step 82, and is determined in transmission or not in Step 87-1. The car service is subjected to a car management information process in Step 83, and is determined in transmission or not in Step 87-2. The mart is subjected to the product information publicity process in Step 84, and is determined in transmission or not in Step 87-3. The advertisement demander is subjected to a product publicity process in Step 85, and is determined in transmission or not in Step 87-4. Further, the construction company is subjected to an apartment publicity process in Step 86, and is determined in transmission or not of the advertisement in Step 87-5. Here, the transmission or not can be determined by referring to a transmission schedule region 108 of an SMS DB 104 shown in FIG. 7.

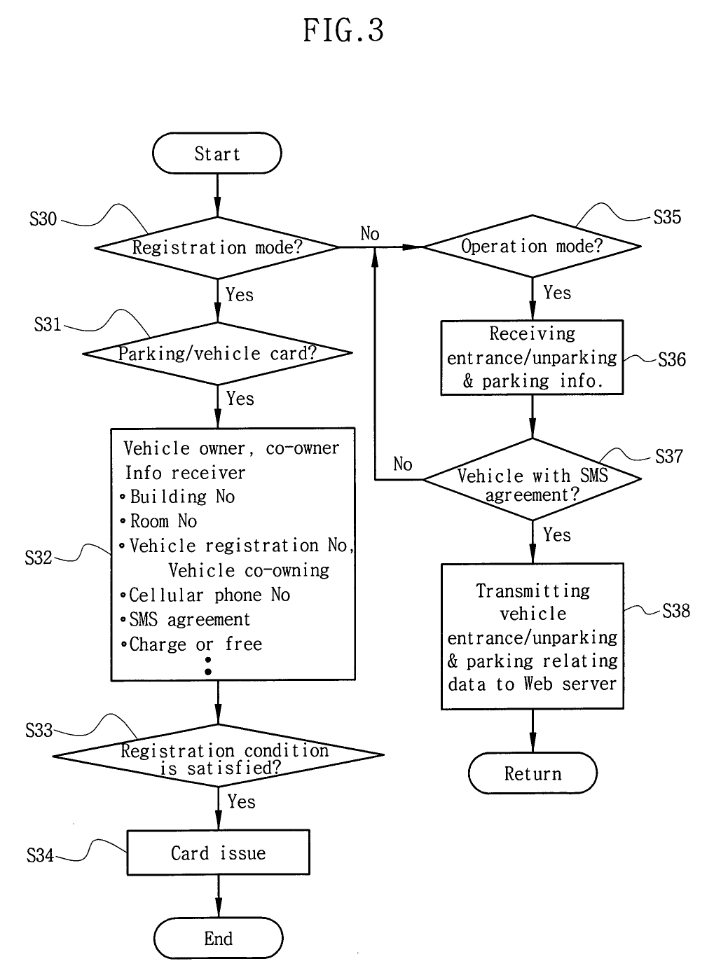

FIG. 3 is a flowchart illustrating an example of operation control of the parking and vehicle management server 60 of FIG. 1. The flowchart is comprised of Steps 30 to 38. In the Step 30, it is checked whether or not there is a registration mode of the vehicle co-owner and co-owners, and in the Step 31, it is checked whether the parking and vehicle card or not. In FIG. 1, the parking card is the first card, and the vehicle card is the second card. In the Step 32, the vehicle owner and co-owner receives information, for example, apartment building and room numbers, vehicle registration number, vehicle co-owning, cellular phone number, SMS agreement or not, and charge or free. In the Step 33, it is checked whether or not the registration condition is satisfied, and in the Step 34, the card is issued.

In the Step 35, it is checked operation mode or not in the case of entrance/unparking or parking, and in the Step 36, the entrance/unparking and parking information is received. In the Step 37, it is checked whether or not to be a short message agreement vehicle. In the case of the short message agreement vehicle, in the Step 38, vehicle entrance/unparking and parking relating data is substantially transmitted to the Web server.

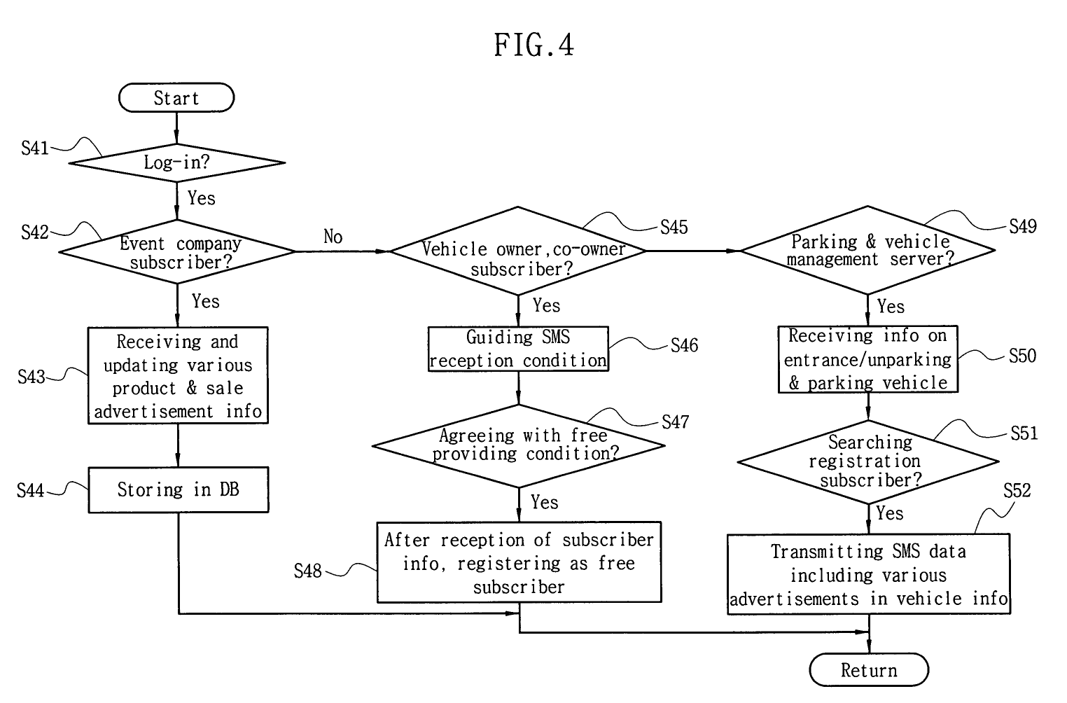

FIG. 4 is a flowchart illustrating an example of operation control of the Web server of FIG. 1. In FIG. 4, in Step 41, login is performed, and in Step 42, it is checked whether or not to be an even company subscriber. In Step 43, various product and sale advertisement information is received/updated. In Step 44, information received and stored in the database is stored.

In Step 45, it is checked whether or not the vehicle owner, co-owner is the subscriber. In Step 46, a short message reception condition is guided. In Step 47 it is checked whether or not a condition of free charge provision is agreed. In Step 48, after subscriber information is received, registration as free charge subscriber is made. In Step 49, it is checked whether or not information is received from the parking and vehicle management server 60, and in Step 50, information on the entrance/unparking and parking vehicle is received. In Step 51, it is checked whether or not to be the registered subscriber registered on the database. In Step 52, the SMS data including various advertisements in the vehicle information is transmitted. The operation control flow of FIG. 4 is achieved by allowing the Web server to interworkingly access data from the interworking database as shown in FIG. 7

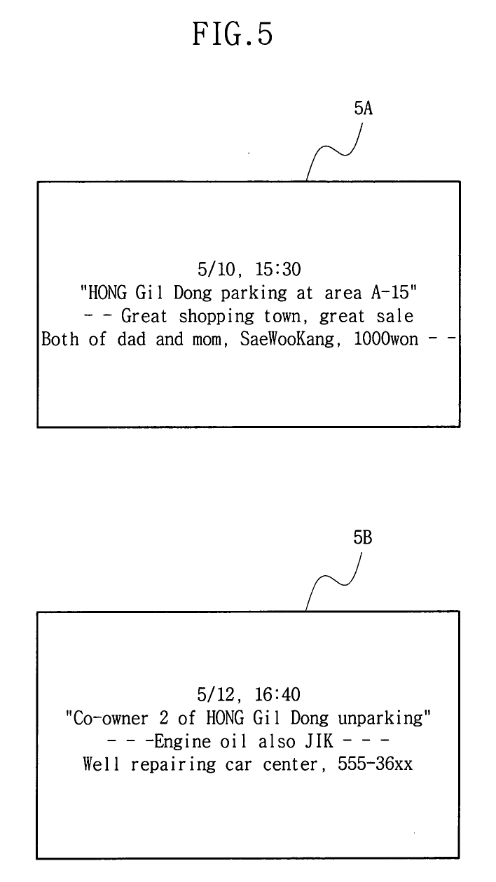

FIG. 5 illustrates an example of a state where a vehicle position information and advertisement message is displayed on a screen of a vehicle co-owner's terminal, based on provision of the short message service according to the present invention.

An upper screen 5A displays that it is informed all other co-owners that a driver “HONG Gil Dong” enters at May 10, 3:30 P.M. and parks the vehicle in an area “A-15”, using a character message. In this case, the advertisement is provided from a mart event company, and its advertisement message is displayed at its upper part as “Discount advertisement for SaeWooKang”

Meantime, a lower screen 5B displays a message of informing that a co-owner 2 of HONG Gil Dong unparks the vehicle at May 12, 4:40 P.M. In this case, the advertisement is provided from a car service relating event company, and its advertisement message is displayed at its lower part as “advertisement for engine oil”

It is natural that instead of directly displaying the vehicle position information, according to need, the short message service can be changed to execute only guidance that a voice message exists, and provide the vehicle position information or entrance/unparking information in voice upon pressing of a voice message check key. Further, in a case further expanded from the short message service, a Multimedia Messaging Service (MMS) can be applied to edit the entrance/unparking or parking position information and the advertisement content into text, mail, music, picture image, and moving picture.

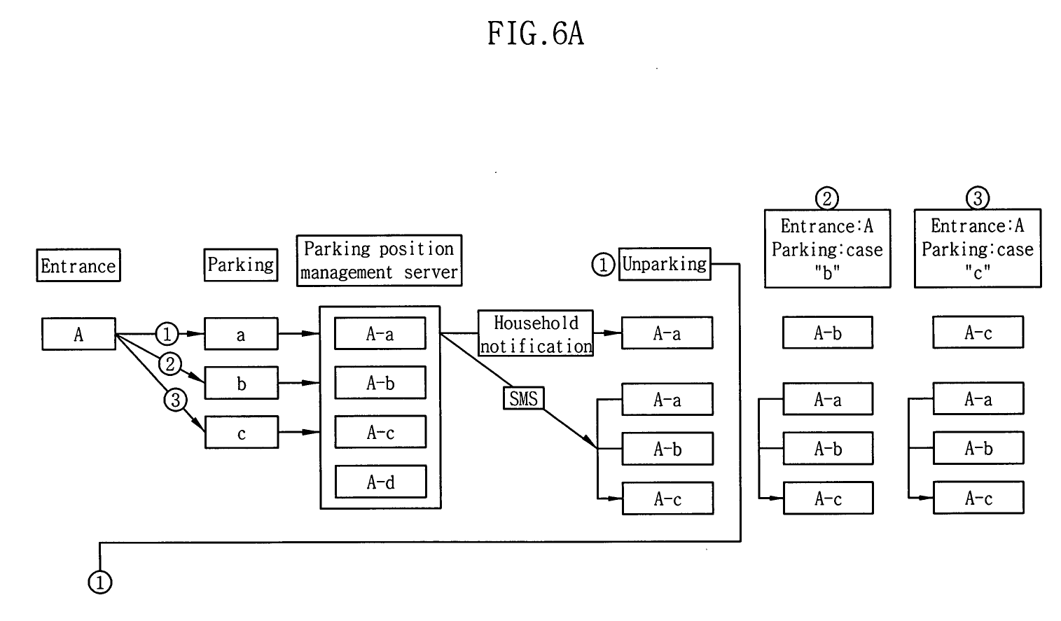

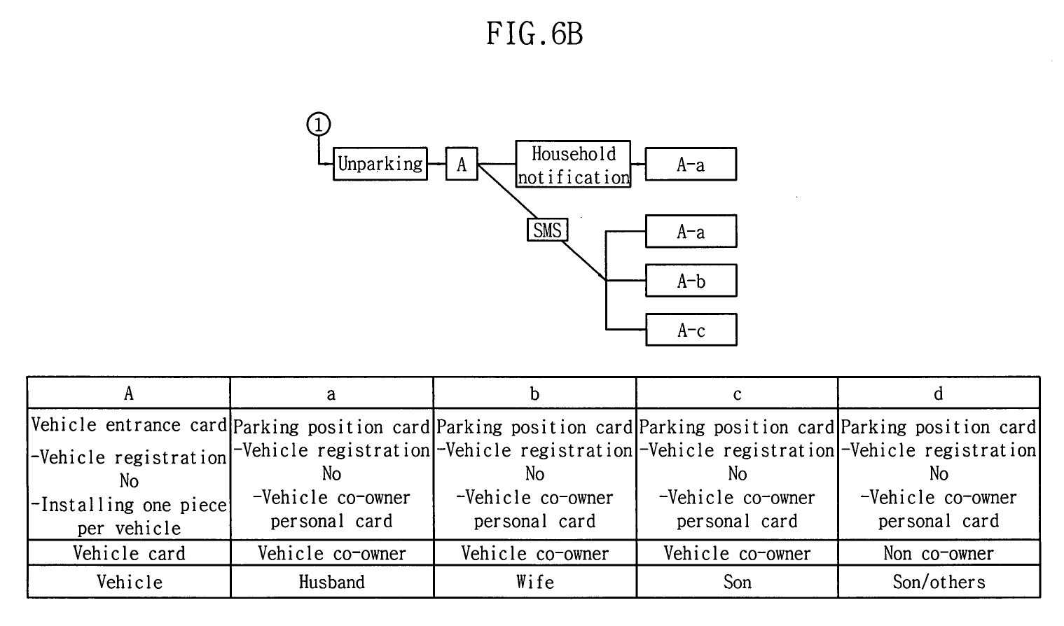

FIG. 6 is a diagram illustrating an exemplary flowchart of a provision path of the short message service of FIG. 5.

Referring to FIG. 6, the card provided for the vehicle is denoted by “A”, the cards provided to the vehicle co-owners are denoted by “a”, “b” and “c”, and a parking position card provided to a vehicle non co-owner is denoted by “d”. For example, in case where a husband being the vehicle co-owner enters the parking lot and contacts the parking position card “a” within a predetermined time, parking information is notified a household “a”, and the parking information through the SMS is transmitted to the wireless terminals of the vehicle co-owners a, b, and c. At this time, as shown in the 5A of FIG. 5, the information having the owner and co-owner and the parking area displayed can be read through the wireless terminals of the vehicle co-owners a, b, and c. Accordingly, a wife or wives and a child or children can know, by confirming the parking position information, the fact that the husband (father) entered the apartment and parked the vehicle anywhere. Meanwhile, when the parking position card “a” is not in contact, the entrance information is selectively notified the household the “a”, and the entrance information using the SMS is transmitted to the wireless terminals of the vehicle co-owners a, b, and c.

Further, similarly with even a case where the co-owner “a” drives and unparks the parked vehicle, the unparking information is notified the household of the “a”, and the unparking information using the SMS is notified the wireless terminals of the vehicle co-owners a, b, and c respectively. If the vehicle co-owner “b” enters the parking lot and contacts the parking position card “b”, the parking information is notified the household of “a”, and the SMS parking information informing that the vehicle co-owner “b” parked the vehicle is transmitted to the wireless terminals of the vehicle co-owners a, b, and c respectively.

FIG. 7 is a diagram illustrating interworking of detail data with a database of a database management system of FIG. 1.

Referring to FIG. 7, the database management system 100 of FIG. 1 mainly includes a parking and vehicle management DB 102, a Web DB 103, and an SMS DB 104 that interwork with one another. A storage region of the parking and vehicle management DB 102 is divided by a tenant data region 105 and a vehicle state and position data region 106. The storage region has various information data 102a stored therein. Various information data 102a stores the vehicle registration number, the household, the building and room numbers, the vehicle owner and co-owner, data on SMS reception permission or not, and the entrance/unparking and parking information. A storage region of the Web DB 103 has an advertisement and guidance data region 107. The storage region stores various information data 103a such as shopping mall, various advertisements, public advertisement, news/publication within the complex, emergency disaster and emergency communication, client's age, sex, and concerns. A transmission schedule region 108 of the SMS DB 104 stores transmission date, time schedule, advertisement content schedule per day, and wireless terminal number.

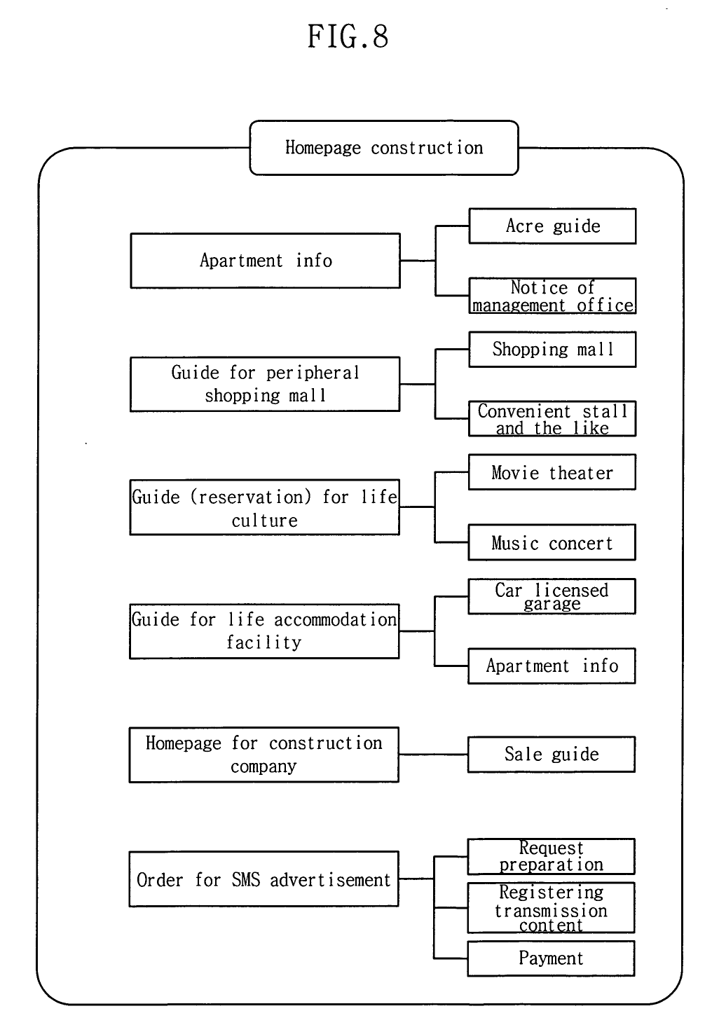

FIG. 8 illustrates an example of a construction screen of a Homepage of the Web server of FIG. 1. Describing a construction of the Homepage firstly viewed from Web pages, there are apartment information, guide for peripheral shopping area, guide (reservation) for life culture, guide for life accommodation facility, Homepage of a construction company, and order for SMS advertisement. After viewing the Homepage, the advertiser of the peripheral shopping area clicks an icon and orders the SMS advertisement. If so, the advertiser performs his/her desiring request through preparation of a request, registration of the transmitted content, and payment. The apartment tenant can click a notice icon of a management office in the apartment information, and request self-information or vehicle updating and new preparation or updating of other profile information.

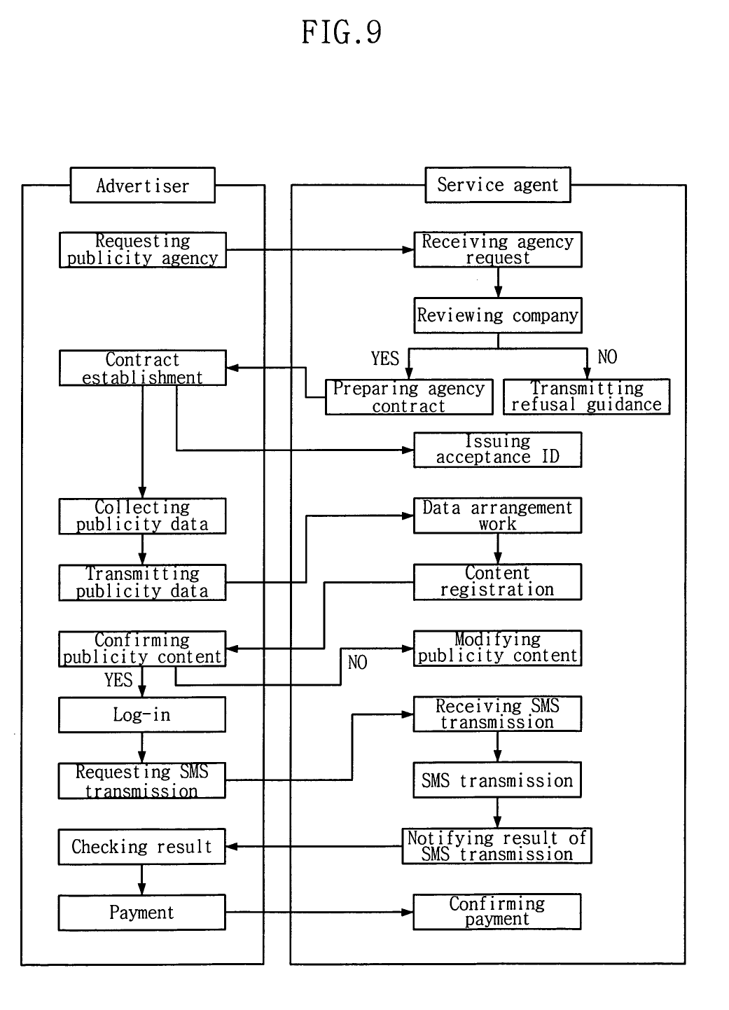

FIG. 9 illustrates a whole flow of an advertisement agent request service in case where the SMS agent company is connected to the event companies of FIG. 1.

Referring to FIG. 9, the advertiser being one of event companies requests the service agent for publicity agency, thereby starting a service. The service agent can be embodied using the Web server 85 of FIG. 1 or another agent server. Upon reception of the agency request, a company check is made, and if it is checked that the company is suitable, an agency contract is prepared and sent to a terminal of the advertiser. Accordingly, if the advertiser permits, the contract is established, and an acknowledgement ID is issued. If the advertiser collects and transmits publicity data through the communication network, the service agent performs a data arrangement work and registers contents. After that, the service agent receives a confirmation of the publicity contents from the advertiser. If there is a modification in the confirmation process, the service agent performs a modification work. If the advertiser logs-in and requests the SMS transmission, the service agent receives and transmit the request of the SMS transmission, and notifies the advertiser of its result. If the advertiser confirms an advertisement transmission result and pays electronic cash, the service agent confirms the payment.

As such, the multilateral SMS service between the vehicle co-owners of the multi-family house can share the vehicle position information resulting from a common use of the vehicle according to the age of a high oil price and a vehicle working-free system and therefore, can provide a service for providing information necessary for a real life. In case where the tenant receives the service transmitted every day, using the SMS service through the cellular phone, there occurs a burden of charging a SMS cost being a service charge. For an example similar with this, a gas cut-off valve control confirmation SMS service using a home network facility installed at the apartment of the multi-family house, or the SMS service using home network control has relation with a user's age, and has the very less number of times of use due to a remarkable low frequency of use.

Unlike this, the inventive vehicle position information SMS service is much more required because parking and entrance/unparking are repeated day by day owing to the multilateral service between the vehicle co-owners of the multi-family house, and the driving of the co-owners is arbitrarily made. Accordingly, the inventive SMS service is provided together with the vehicle position information, the publicity and advertisement linked with area information, and news of the complex, thereby allowing the vehicle co-owners to use the service with cost saving or without charge, and allowing the related publicity company and the advertisement company using the SMS service to use the service under permission of the vehicle co-owner and transmit information SMS having information and publicity combined to the tenant. In order to provide the service, a system building-up is required as in FIG. 1, and the service can be provided to the vehicle co-owner through the interworking server using the SMS of the cellular phone. In order to provide a free-charged service, the system can be the car service company located at the area, and can be a grant shopping mall, a grand mart, a complex shopping area, the construction company, and the demander needing the advertisement and publicity, and can be used as a medium for transmitting the news of the complex in the complex management office.

In order to provide the vehicle position information SMS service, a contents provider-oriented SMS service where the SMS agent synthetically collects, manages and transmits the information of the advertisement demander can be embodied. If the vehicle co-owner agrees with an SMS free-transmission contract, a server of a contents provider receives the parking and unparking data, and combines the received data with the advertisement and event information whenever receiving the parking and unparking data, to transmit the combined information to the SMS server and the SMS message to the cellular phone of the vehicle co-owner. For example, the parking information and publicity and advertising SMS will be able to be transmitted to the vehicle co-owners, such as the shopping mall “HONG Gil Dong parks in area of A-15 on May 10 and at 15:30, 00 shopping town, all products discounted by 10%”, the mart “HONG Gil Dong parks in area of A-15 on May 10 and at 15:30, food discounted by 30%”, the construction company “HONG Gil Dong parks in area of A-15 on May 10 and at 15:30, Congratulation to your entrance”, and the management office “HONG Gil Dong parks in area of A-15 on May 10 and at 15:30, meeting to be held on May 15”. As such, if the contents provider oriented multilateral SMS vehicle position information service agent is used for the multi-family house co-owner, the peripheral publicity and advertisement demander can be collected and its resultant various advertisement and publicity can be sequentially transmitted or can be combined and transmitted with the event information. Accordingly, there is an effect in that the SMS vehicle position information service agent creates a profit through a contract with the advertiser, and can make a contract for the service transmission and a profit contract for advertisement and publicity, and the vehicle co-owner can advantageously receive the vehicle position information service without charge.

If the vehicle co-owners desires to receive his/her suitable concerned information from the service, he/she can subscribe to the Homepage of the advertiser through his/her PC 75 input self-information, and receive relation information as a customized SMS. Accordingly, even when the vehicle is parked and unparked, the vehicle co-owner receives the SMS vehicle position information and his/her concerning product information and is discriminated, and can receive a service only for himself/herself, he/she can receive the information and customized product information. For example, in the apartment employing a technique of the multilateral SMS vehicle position information for the vehicle co-owner of the multi-family house, the vehicle owner subscribes the Homepage of the vehicle service company, and writes the self-information and the vehicle information, that is, a vehicle production year, a vehicle kind, running distance, the frequency number of use, the vehicle co-owner transmits the multilateral SMS vehicle position information of the vehicle co-owner according to the present invention through the cellular phone, the vehicle position notification and the vehicle relating service information such as “HONG Gil Dong parks on May 10 and 10:00 at area of A-15, Replacement of engine oil when running reaches 150000 Km” can be transmitted. The system construction can be made even by an external SMS parking position information agent, and the construction can be used even in the complex itself to construct the SMS vehicle position information service. Further, if the inventive system is applied to a newly built apartment, the vehicle position information within the complex is provided to a client while the apartment publicity is performed, thereby achieving external brand enhancement, and it will be convenient to connect newly built apartments for publicity and advertisement. These technologies are based on the multilateral SMS vehicle position information system of the multi-family house, it can be considered to belong to the inventive technology.

As described above, the present invention has an effect in that the vehicle co-owners of the multi-family house can receive the vehicle entrance, unparking or parking information or the existence or absence of the theft according to his/her desire, without charge by the short message, and the advertisement participating companies can transmit their desiring advertisement message to the vehicle owner and co-owners at a low price.

While the present invention has been described with reference to exemplary embodiments thereof, it will be apparent to those skilled in the art that various modifications can be made therein without departing from the spirit and scope of the invention as defined by the appended claims and their equivalents. For example, it is natural that the Multimedia Messaging Service can be applied further to the SMS, thereby editing and transmitting the entrance/unparking or parking position information and the advertisement contents by text, mail, music, picture image, moving picture.

1. A device for providing vehicle position information, the device comprising:
a first card reader for reading vehicle relating information from a card provided to a vehicle at the dine of entrance/unparking of the vehicle;
a second card reader for reading parking relating information from one of cards provided to vehicle co-owners of a multi-family house at the time of parking of the vehicle;
a parking and vehicle management server for previously storing information relating to the vehicle co-owners, and connected with the first and second card readers to receive the vehicle and parking relating information and perform a parking and entrance/unparking management of the vehicle;
a Web server for receiving advertisement message data from event companies and storing the received advertisement message data, and connected to the parking and vehicle management server and the event companies through a communication network to generate vehicle position or state information relating short message data, which selectively includes the stored advertisement message data, at the time of the entrance, unparking or parking of the vehicle; and
a short message transmitting server connected with the Web server, and when it is requested to transmit the short message data, transmitting the short message to wireless terminals of vehicle co-owners of the multi-family house.

2. The device according to claim 1, wherein in case where the vehicle co-owners receive the short message including the advertisement message, a transmission cost of the short message is set to be imposed on the event companies.

3. The device according to claim 2, wherein, by receiving the vehicle position and state information relating short message, the vehicle co-owners can recognize vehicle entrance, unparking, parking position, or theft or not.

4. The device according to claim 2, wherein the cards provided to the vehicle co-owners are contact or proximal cards, and the card provided to the vehicle is a recognizable RF card in its non-contact state.

5. A method for providing vehicle position information, the method comprising the steps of:
reading vehicle relating information from cards provided to vehicle co-owners of a multi-family house and a vehicle at the time of entrance/parking and parking of the vehicle;
performing a parking and entrance/unparking management of the vehicle in response to the vehicle relating information; and
generating vehicle position and state information relating short message selectively including an advertisement message provided from advertisement requesting companies, and transmitting the generated short message to wireless terminals of the vehicle co-owners at the time of entrance/unparking or parking of the vehicle.

6. The method according to claim 5, wherein in case where the vehicle co-owners receive the short message including the advertisement message, a transmission cost of the short message is set to be imposed on the advertisement requesting companies.

7. The method according to claim 6, wherein, by receiving the vehicle position and state information relating short message, the vehicle co-owners can recognize vehicle theft or not.

8. The method according to claim 6, wherein the vehicle co-owners can listen a parking position state of the vehicle even through a voice message, by receiving the short message.

9. A vehicle position information providing method, comprising the steps of:
reading vehicle relating information from cards provided to vehicle co-owners of a multi-family house and a vehicle at the time of entrance/unparking or parking of the vehicle;
performing a parking and entrance/unparking of the vehicle in response to the vehicle relating information; and
synthetically generating vehicle position and state information relating multimedia message selectively including an advertisement message provided from public and commercial advertisement requesting companies, and transmitting the generated multimedia message to wireless terminals of the vehicle co-owners.

10. The method according to claim 9, wherein the multimedia message comprises at least one of text, music, image, and moving picture.

11. (canceled)
